(19) United States
(12) Patent Application Publication
(10) Pub. No.: US 2026/0044407 A1
(43) Pub. Date: Feb. 12, 2026

(54) SYSTEM AND METHOD FOR PROVIDING AUTOMATED RESOLUTION IN AN ENTERPRISE IT ENVIRONMENT

(71) Applicant: Amit JALALI, New Delhi (IN)

(72) Inventor: Amit JALALI, New Delhi (IN)

(21) Appl. No.: 18/917,159

(22) Filed: Oct. 16, 2024

Related U.S. Application Data
(63) Continuation of application No. PCT/IB2024/059227, filed on Aug. 9, 2024.

(30) Foreign Application Priority Data
Sep. 23, 2024 (IN) 202411060469

(51) Int. Cl. G06F 11/07

(52) U.S. Cl. CPC G06F 11/0793; G06F 11/0709

(57) ABSTRACT

The present subject matter relates to a system (100) and a method (300) for providing automated resolution to one or more anomalous events in an enterprise information technology (IT) environment. The system (100) integrates a processor (201) and a memory (202) that stores instructions to execute various tasks. The system (100) monitors activities within the enterprise IT environment, identifies one or more anomalous events, and correlates the identified anomalous events with one or more predefined resolution workflows. Each workflow includes specific operating instructions tailored to address the identified anomalies. Upon detecting an anomaly, the system (100) extracts the relevant operating instructions from the corresponding workflow and executes them to resolve the issue. Thus, the system (100) significantly reduces the mean time to resolve by automating the detection and resolution of anomalies, thereby improving operational efficiency and minimizing downtime in the enterprise IT environment.

### CROSS-REFERENCE TO RELATED APPLICATIONS AND PRIORITY

The present application is a continuation application of International Application No. PCT/IB2024/059227, filed Sep. 23, 2024, which claims priority to Indian Patent Application No. 202411060469, filed Aug. 9, 2024. The contents of these applications are incorporated herein by a reference in their entirety.

### FIELD OF INVENTION

The presently disclosed embodiments are related, in general, to the field of information technology (IT) systems. More particularly, the presently disclosed embodiments are related to a system and a method for providing automated resolution to one or more anomalous events in an enterprise information technology (IT) environment.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the dynamic landscape of enterprise information technology (IT), the ability to swiftly and effectively address anomalous events is crucial for maintaining operational efficiency and minimizing downtime. Traditional methods of incident management, particularly at the L2 and L3 levels, often involve human based labour-intensive processes that can delay resolution and strain IT resources. Despite advancements in monitoring and automation tools, conventional IT systems still face several challenges in handling and resolving issues across the entire support spectrum from L1 to L4.

Conventional IT systems face significant challenges in effectively managing and resolving incidents across different levels of support, particularly in complex enterprise environments. These systems often emphasize Mean Time to Find Problems (MTFP), focusing more on identifying and reporting failures rather than efficiently resolving issues once they occur. This approach leads to prolonged downtimes and inefficiencies, as traditional systems primarily detect issues and notify users without providing comprehensive solutions. The reliance on manual processes for logging, categorizing, and resolving incidents further exacerbates the problem, introducing delays and a higher potential for human error. Moreover, traditional systems are often overwhelmed by the high volume of repetitive, low-complexity incidents at the L1 support level, which delays attention to more critical issues and increases overall time to resolve the issue.

One significant problem is the dependency on manual processes for problem identification and resolution. L1 support typically involves handling routine issues such as password resets and basic troubleshooting, which can be automated effectively. However, when issues escalate to L2 and L3, which require more in-depth technical knowledge and problem-solving skills, traditional systems often rely heavily on human technicians. These technicians must sift through logs, correlate data from various sources, and perform complex analyses to identify the root cause of the problem. This manual approach is time-consuming and prone to errors, leading to increased mean time to resolve (MTTR) the issue.

Moreover, conventional systems often struggle with contextual understanding and accurate issue classification. These systems may operate based on predefined scripts and lack the sophisticated contextual awareness needed to handle complex scenarios. As a result, they may misclassify issues or fail to recognize the nuanced differences between similar problems, leading to incorrect diagnoses and ineffective resolutions. This not only delays the resolution process but also necessitates additional manual intervention to correct these errors, further straining IT resources.

For L2 and L3 support, which involve more specialized and complex problem-solving, conventional IT systems struggle with identifying the root cause of issues due to the extensive manual investigation required. This process not only prolongs the resolution time but also ties up skilled technicians with routine tasks that could be automated, leading to inefficient resource utilization. Coordination among multiple support teams is another challenge, as traditional systems lack streamlined communication and collaboration tools, resulting in fragmented efforts and slower resolution times. Additionally, these systems often concentrate on infrastructural layers, such as CPU and network, neglecting the end-user layer that includes applications and cybersecurity, thereby providing a limited scope of support.

Handling exceptions is another critical challenge. L2 and L3 issues frequently involve unique or uncommon situations that fall outside the scope of standard operating procedures (SOPs). Processes in the conventional systems, designed to follow strict guidelines, may falter when faced with these exceptions. Without the ability to adapt dynamically to unforeseen problems, the conventional processes may either escalate the issue to human technicians or apply inappropriate solutions, both of which can prolong the resolution time and increase the workload on IT staff.

In light of the above stated discussion, there exists a need of a system and a method for providing automated resolution to one or more anomalous events in an enterprise information technology (IT) environment to overcome at least one of the above stated problems.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

According to embodiments illustrated herein, a method for providing automated resolution to one or more anomalous events in an enterprise information technology (IT) environment is disclosed. In one implementation of the present disclosure, the method may involve various steps performed by a processor. The method may involve a step of monitoring one or more activities running in the enterprise IT environment. Further, the method may involve a step of identifying the one or more anomalous events from the one or more activities. Furthermore, the method may involve a step of identifying one or more predefined resolution workflows corresponding to the identified one or more anomalous events. In an embodiment, the one or more predefined resolution workflows may comprise one or more operating instructions. Furthermore, the method may involve a step of extracting the one or more operating instructions corresponding to the identified one or more predefined resolution workflows. Moreover, the method may involve a step of executing the one or more extracted operating instructions for providing resolution to the one or more anomalous events in the enterprise information technology (IT) environment.

According to embodiments illustrated herein, a system to provide automated resolution to the one or more anomalous events in the enterprise information technology (IT) environment is disclosed. In one implementation of the present disclosure, the system may involve a processor and a memory. The memory is communicatively coupled to the processor. Further, the memory is configured to store processor executable instructions, which, on execution, may cause the processor to monitor one or more activities running on the enterprise IT environment. Further, the processor may be configured to identify the one or more anomalous events from the one or more activities. Furthermore, the processor may be configured to identify the one or more predefined resolution workflows corresponding to the identified one or more anomalous events. In an embodiment, the one or more predefined resolution workflows may comprise the one or more operating instructions. Furthermore, the processor may be configured to extract the one or more operating instructions corresponding to the identified one or more predefined resolution workflows. Moreover, the processor may be configured to execute the one or more extracted operating instructions for providing resolution to the one or more anomalous events in the enterprise information technology (IT) environment.

According to embodiments illustrated herein, there is provided a non-transitory computer-readable storage medium having stored thereon, a set of computer-executable instructions causing a computer comprising one or more processors to perform various steps. The steps may involve monitoring the one or more activities running on the enterprise IT environment. Further, the steps may involve identifying the one or more anomalous events from the one or more activities. Further, the steps may involve identifying the one or more predefined resolution workflows corresponding to the identified one or more anomalous events. In an embodiment, the one or more predefined resolution workflows may comprise the one or more operating instructions. Further, the steps may involve extracting the one or more operating instructions corresponding to the identified one or more predefined resolution workflows. Moreover, the steps may involve executing the one or more extracted operating instructions for providing resolution to the one or more anomalous events in the enterprise information technology (IT) environment.

The foregoing summary is illustrative only and is not intended to be in any way limiting. In addition to the illustrative aspects, embodiments, examples, and features described above, further aspects, embodiments, and features will become apparent by reference to the drawings and the following detailed description.

### BRIEF DESCRIPTION OF DRAWINGS

The detailed description is described with reference to the accompanying figures. In the figures, same numbers are used throughout the drawings to refer like features and components. Embodiments of a present disclosure will now be described, with reference to the following diagrams below wherein:

FIG. 1 illustrates a block diagram describing a system (100) to provide automated resolution to one or more anomalous events in an enterprise information technology (IT) environment, in accordance with at least one embodiment of present subject matter.

FIG. 2 illustrates a block diagram (200) showing an overview of various components of an application server (101) configured for providing automated resolution to the one or more anomalous events in the enterprise information technology (IT) environment, in accordance with at least one embodiment of present subject matter.

FIG. 3 illustrates a flowchart describing a method (300) for providing automated resolution to the one or more anomalous events in the enterprise information technology (IT) environment, in accordance with at least one embodiment of present subject matter, and

FIG. 4 illustrates a block diagram (400) of an exemplary computer system (401) for implementing embodiments consistent with the present subject matter.

It should be noted that the accompanying figures are intended to present illustrations of exemplary embodiments of the present disclosure. These figures are not intended to limit the

scope of the present disclosure. It should also be noted that accompanying figures are not necessarily drawn to scale.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

The present disclosure relates to a system to provide automated resolution to one or more anomalous events in an enterprise information technology (IT) environment. The system comprises a processor and a memory communicatively coupled to the processor, and the memory is configured to store processor-executable instructions. Further, the system enables the processor to monitor one or more activities running on the enterprise IT environment. Further, the system may identify the one or more anomalous events from the one or more activities. Furthermore, the system may identify one or more predefined resolution workflows corresponding to the identified one or more anomalous events. In an embodiment, the one or more predefined resolution workflows may comprise one or more operating instructions. Furthermore, the system may extract the one or more operating instructions corresponding to the identified one or more predefined resolution workflows. Moreover, the system may execute the one or more extracted operating instructions for providing resolution to the one or more anomalous events in the enterprise information technology (IT) environment. This approach streamlines the incident management process, significantly reducing the mean time to resolve (MTTR) by automating the detection and resolution of IT support problems. By leveraging predefined workflows, the system ensures consistent and efficient handling of the one or more anomalous events, enhancing overall operational efficiency and minimizing downtime in the enterprise IT environment.

To address the problems of conventional systems, the disclosed system focuses on integrating automated technologies (referred to as automated bots interchangeably) into IT support frameworks to efficiently identify and resolve the one or more anomalous events, thereby enhancing operational efficiency. By automating routine tasks and handling repetitive L1 incidents swiftly, the automated technologies enable human technicians to concentrate on more complex problems. Leveraging standard operating procedures (SOPs), the bots not only L1, but effectively manage L2 and L3 issues without the need for extensive technical expertise from human technicians. By integrating bots into IT support systems, bots identify and resolve issues based on predefined workflows and historical data, thereby minimizing manual intervention. Thus, the system enhances the speed and accuracy of problem identification and resolution, significantly reducing the mean time to resolve (MTTR) and allowing IT teams to focus on more strategic tasks.

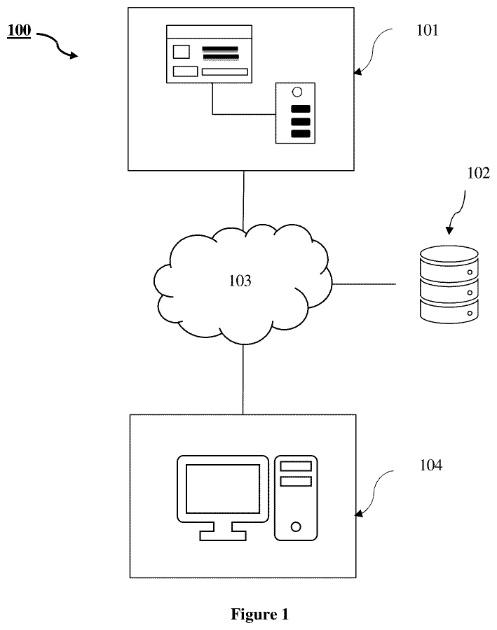

Referring to FIG. 1 is a block diagram that illustrates a system (100) to provide automated resolution to one or more anomalous events in an enterprise information technology (IT) environment, in accordance with at least one embodiment of the present subject matter. The system (100) typically comprises an application server (101), a database server (102), a communication network (103), and a user computing device (104). The application server (101), the database server (102), and the user computing device (104) are typically communicatively coupled with each other via the communication network (103). In an embodiment, the application server (101) may communicate with the database server (102), and the user computing device (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may refer to a computing device that may be configured to store one or more activities, set of predefined rules, one or more predefined resolution workflows including one or more operating instructions. The database server (102) may include a special purpose operating system specifically configured to perform one or more database operations on the one or more activities performed by a user. In an embodiment, the database server (102) may include a centralized repository specifically configured for storing the one or more predefined resolution workflows corresponding to the one or more anomalous events. The centralized repository is specifically configured to perform one or more database operations providing access of the one or more predefined resolution workflows, to one or more bots corresponding to the one or more anomalous events. Further, the centralized repository is configured to perform the one or more database operations such as searching for one or more predefined resolution workflows corresponding to the one or more anomalous events. Further, the central repository is configured to perform the one or more database operations such as logging each step of instruction from the one or more operating instructions, executed for providing resolution to the one or more anomalous events in the enterprise IT environment. In an exemplary embodiment, logging may correspond to storing screenshots of actions performed while executing the one or more operating instructions. In another exemplary embodiment, logging may correspond to maintaining a history of actions performed by the one or more bots while executing the one or more operating instructions. Examples of database operations may include, but are not limited to, storing, retrieving, logging, and managing data. In an embodiment, the database server (102) may include hardware that may be configured to perform one or more predetermined operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for storage and retrieval of data used for providing automated resolution to the one or more anomalous events in the enterprise IT environment and for effectively managing the automated identification, resolution, and documentation of anomalous events in the enterprise IT environment.

A person with ordinary skills in art will understand that the scope of the disclosure is not limited to the database server (102) as a separate entity. In an embodiment, the functionalities of the database server (102) can be integrated into the application server (101) or into the user computing device (104).

In an embodiment, the application server (101) may refer to a computing device or a software framework hosting an application or a software service. In an embodiment, the application server (101) may be implemented to execute procedures such as, but not limited to, programs, routines, or scripts stored in the database server (102) for supporting the hosted application or the software service. In an embodiment, the hosted application or the software service may be configured to perform one or more predetermined operations. The application server (101) may be realized through various types of application servers such as, but are not limited to, a Java application server, a .NET framework application server, a Base4 application server, a PHP framework application server, or any other application server framework.

In an embodiment, the application server (101) may be configured to utilize the database server (102) and the user computing device (104), in conjunction, for providing automated resolution to the one or more anomalous events in the enterprise IT environment. In an implementation, the application server (101) corresponds to execution of automated resolution, thereby facilitating the monitoring of one or more activities, identification of the one or more anomalous events, identification of one or more predefined resolution workflows comprising the one or more operating instructions, extracting the one or more operating instructions, and execution of the predefined operating instructions, ensuring efficient and effective resolution of issues within the enterprise IT environment.

In an embodiment, the application server (101) may be configured to monitor the one or more activities running on the enterprise IT environment.

In an embodiment, the application server (101) may be configured to identify the one or more anomalous events from the one or more activities.

In an embodiment, the application server (101) may be configured to identify one or more predefined resolution workflows corresponding to the identified one or more anomalous events. In an embodiment, the one or more predefined resolution workflows may include one or more operating instructions.

In an embodiment, the application server (101) may be configured to extract the one or more operating instructions corresponding to the identified one or more predefined resolution workflows.

In an embodiment, the application server (101) may be configured to execute the one or more extracted operating instructions for providing resolution to the one or more anomalous events in the enterprise information technology (IT) environment.

In an embodiment, the communication network (103) may correspond to a communication medium through which the application server (101), the database server (102), and the user computing device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device (104) may comprise one or more processors and one or more memory. The one or more memory may include computer readable instructions that may be executable by one or more processors to perform predetermined operations of the system (100). In an embodiment, the user computing device (104) may present a web user interface to display operations performed by the application server (101). Example web user interfaces presented on the one or more portable devices to display a visualization dashboard which facilitates a task management functionality to the one or more stakeholders. Examples of the user computing device (104) may include, but are not limited to, a personal computer, a laptop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it can concurrently and instantly provide automated resolution to the one or more anomalous events in the enterprise information technology (IT) environment in collaboration with other systems. In a specific embodiment, the system (100) is implemented to provide automated resolution to the one or more anomalous events in the enterprise information technology (IT) environment.

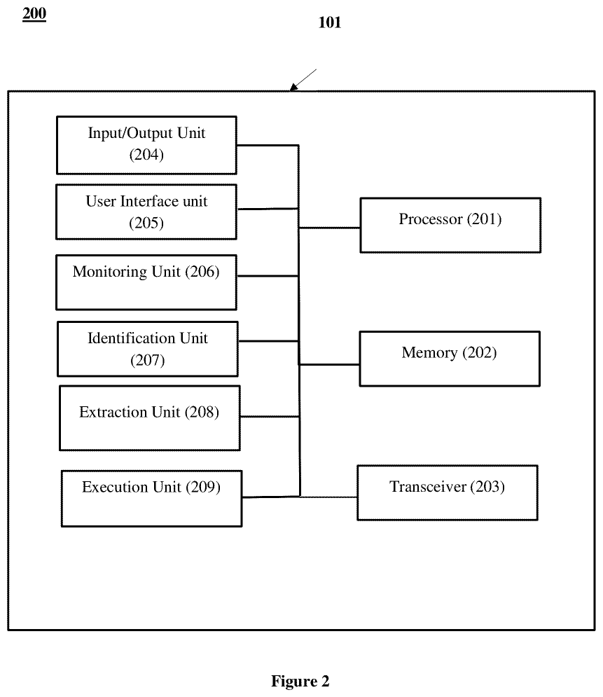

Now referring to FIG. 2, illustrates a block diagram (200) showing an overview of various components of the application server (101) configured for providing automated resolution to the one or more anomalous events in the enterprise information technology (IT) environment, in accordance with at least one embodiment of the present subject matter. FIG. 2 is explained in conjunction with elements from FIG. 1. In an embodiment, the application server (101) includes a processor (201), a memory (202), a transceiver (203), an input/output unit (204), a user interface unit (205), a monitoring unit (206), an identification unit (207), an extraction unit (208), and an execution unit (209). The processor (201) may be communicatively coupled to the memory (202), the transceiver (203), the input/output unit (204), the user interface unit (205), the monitoring unit (206), the identification unit (207), the extraction unit (208), and the execution unit (209). The transceiver (203) may be communicatively coupled to the communication network (104) of the system (100).

In an embodiment, the automated resolution may be provided by one or more bots corresponding to the one or more anomalous events. In an embodiment, the one or more bots are communicatively coupled with the processor (201). In an embodiment, the one or more bots may be configured for resolving the one or more anomalous events by mapping a specific bot from the one or more bots for a specific anomalous event from the one or more anomalous events. In an embodiment, the automated resolution provided by the one or more bots may correspond to one of Level 1 (L1) resolution, Level 2 (L2) resolution, Level 3 (L3) resolution, Level 4 (L4) resolution, or a combination of the same.

In an exemplary embodiment, the L1 resolution relates to basic support tasks such as password resets, user account management, and handling straightforward issues or queries. Typically involves standard procedures and scripts to resolve common, low-complexity problems. Further, the L2 resolution relates to intermediate support for more complex issues that the L1 resolution technique/bots may not resolve. This includes troubleshooting software and hardware problems, configuring system settings, and performing deeper analysis based on error logs and user reports. For example, troubleshooting a network connectivity issue affecting multiple users. Furthermore, L3 resolution relates to advanced support involving high-level technical expertise. L3 addresses complex issues that require in-depth knowledge of the system's architecture, custom applications, and underlying code. For example, diagnosing and fixing a complex software bug within a custom application. Moreover, L4 resolution relates to expert-level support that may involve external vendors or developers. L4 deals with issues that are beyond the internal IT team's control, such as major system overhauls, integrations, or issues with third-party applications. L4 often includes system design changes and advanced troubleshooting. For example, coordinating with a third-party vendor to resolve a critical system integration problem.

The processor (201) comprises suitable logic, circuitry, interfaces, and/or code that may be configured to execute a set of instructions stored in the memory (202), and may be implemented based on several processor technologies known in the art. The processor (201) works in coordination with the memory (202), the transceiver (203), the input/output unit (204), the user interface unit (205), the monitoring unit (206), the identification unit (207), the extraction unit (208), and the execution unit (209) for providing automated resolution to the one or more anomalous events in the enterprise information technology (IT) environment. Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signals, programs, routines or scripts through the communication network (103).

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other user computing devices (104), some of which may be built in. Illustrative components include tablets, mobile phones, wireless devices, etc.

Further, the input/output (I/O) unit (204) may be configured to display a visualization dashboard for the one or more stakeholders. In an embodiment, the visualization dashboard corresponds to indicating the one or more anomalous events, the one or more operating instructions executed for providing resolution to the one or more identified anomalous events, current status, and one or more impacting workflows. In an embodiment, the visualization dashboard corresponds to a visualization report to one or more stakeholders on the one or more identified anomalous events and the one or more operating instructions executed for providing resolution to the one or more identified anomalous events. In an embodiment, reporting may include sending alerts to the one or more stakeholders on one or more user devices associated with the one or more stakeholders. In an embodiment, displaying the visualization dashboard facilitates the task management functionality to the one or more stakeholders.

Further, the user interface unit (205) may facilitate interaction between the one or more stakeholders and an automated resolution system (100) by presenting relevant data, alerts, and notifications about one or more anomalous events and corresponding resolution status. The user interface unit (205) may allow the one or more stakeholders to view the status of ongoing resolutions and to receive real-time updates on issue resolution progress. Furthermore, the user interface unit (205) may include interfaces for various content formats such as text, image, video, and audio. These components work together to provide automated resolution to the one or more anomalous events, thereby effectively monitoring, managing and resolving IT issues within the enterprise IT environment.

Further, the monitoring unit (206) may be configured to monitor the one or more activities running on the enterprise IT environment. In an embodiment, the monitoring of the one or more activities, running on the enterprise IT environment, may be performed in coordination with one or more native monitoring platforms hosted on the enterprise IT environment. In another embodiment, the monitoring of the one or more activities, running on the enterprise IT environment, may correspond to applying a set of predefined rules on the one or more activities.

In an exemplary embodiment, the one or more native monitoring platforms hosted on the enterprise IT environment may include Microsoft System Center Operations Manager (SCOM), Nagios, Zabbix, Dynatrace, Influx DB, IBM Tivoli Monitoring, and more.

Further, the identification unit (207) may be configured to identify the one or more anomalous events from the one or more activities. In an embodiment, the identification unit (207) may allow the one or more anomalous events to be validated by the one or more stakeholders, to confirm validity of the identified one or more anomalous events. Moreover, the identification unit (207) may be configured to identify the one or more anomalous events from the one or more activities, based on one or more tickets from one or more native ticketing platforms hosted on the enterprise IT environment. In an exemplary embodiment, the one or more anomalous events may include, but not limited to, scenarios like a non-complying user action on a regular task, clicking on link/URL on phishing email,

downloading an attachment from an unknown source, entering credentials into a suspicious website, non-complying activity on the enterprise IT environment, executable file as email attachment.

Furthermore, the identification unit (207) may be configured to identify the one or more predefined resolution workflows corresponding to the identified one or more anomalous events. In an embodiment, each predefined resolution workflow from the one or more predefined resolution workflows may include the one or more operating instructions. The one or more operating instructions comprises a sequence of operating instructions, to be executed in a predefined order for providing resolution to the one or more anomalous events. In another embodiment, the one or more operating instructions may correspond to one or more Standard Operating Procedures (SOPs) for providing resolution to the one or more anomalous events.

In an implementation, the automated resolution is provided by one or more bots corresponding to the one or more anomalous events. In an embodiment, the identification unit (207) may be configured to identify one or more bots, for providing the automated resolution, corresponding to the one or more anomalous events. The one or more bots are configured for resolving the one or more anomalous events through mapping a specific bot from the one or more bots for a specific anomalous event from the one or more anomalous events. The one or more bots may be communicatively coupled with the processor (201).

In an implementation, the one or more predefined resolution workflows corresponding to the one or more anomalous events may be stored into a centralized repository. In an embodiment, identifying the one or more predefined resolution workflows corresponds to searching the one or more predefined resolution workflows corresponding to the identified one or more anomalous events, stored into the centralized repository. In another embodiment, identifying the one or more predefined resolution workflows corresponds to providing access of the one or more predefined resolution workflows, stored into the centralized repository, to the one or more bots corresponding to the one or more anomalous events.

Furthermore, the identification unit (207) may be configured to identify the one or more bots corresponding to the one or more anomalous events based on one or more user profiles. In an embodiment, the one or more user profiles may correspond to one or more access permissions provided to users for providing at least one of L1, L2, L3, L4, L5 resolutions and a combination of the same. In an exemplary embodiment, the automated resolution provided by the one or more bots corresponds to one of Level 1 (L1) resolution, Level 2 (L2) resolution, Level 3 (L3) resolution, Level 4 (L4) resolution, or a combination thereof.

Additionally, the identification unit (207) may be configured to predict risks of upcoming anomalous events based on monitoring of the one or more activities, using one or more predictive analysis techniques. In an exemplary embodiment, the one or more predictive techniques may include predictive analytics, machine learning algorithms, risk assessment models, and more.

Furthermore, the extraction unit (208) may be configured to extract the one or more operating instructions corresponding to the identified one or more predefined resolution workflows. In an embodiment, the one or more operating instructions may include a sequence of operating instructions, to be executed by the one or more bots, in a predefined order for providing resolution to the one or more anomalous events. In an embodiment, extracting of the one or more operating instructions corresponds to parsing of the one or more operating instructions using one or more parsing tools. The one or more parsing tools comprise but not limited to, Microsoft enabled technologies Powershell scripting, Power Apps, Power Automate, Power BI, SharePoint online or more.

Furthermore, the execution unit (209) may be configured to execute the one or more operating instructions, extracted by the extracting unit (208), for providing resolution to the one or more anomalous events in the enterprise information technology (IT) environment. The execution of the one or more operating instructions corresponds to executing the sequence of instructions in the predefined order as defined in the corresponding resolution workflow. In the case of existing more than one predefined resolution workflows applicable for an anomalous event, then all the one or more operating instructions corresponding to all the predefined workflows are executing in unison.

Furthermore, the execution unit (209) may be configured for logging into the central repository or the database server (102), each step of instruction from the one or more operating instructions, executed for providing resolution to the one or more anomalous events in the enterprise information technology (IT) environment. The logging may correspond to taking screenshots of actions performed while executing the one or more operating instructions. The logging may correspond to maintaining history of actions performed by the one or more bots while executing the one or more operating instructions.

Post execution of the one or more resolution workflows corresponding to the one or more anomalous events, the application server (101) may be configured to report, to one or more stakeholders, the one or more identified anomalous events and the one or more operating instructions executed for providing resolution to the one or more identified anomalous events. The reporting may corresponds to sending alerts to the one or more stakeholders on one or more user devices associated with the one or more stakeholders. Furthermore, the application server (101) may be configured to displaying a visualization dashboard to the one or more stakeholders. The visualization dashboard may indicate at least the one or more anomalous events, the one or more operating instructions executed for providing resolution to the one or more identified anomalous events, current status, and an impacting workflow. Displaying the visualization dashboard may facilitate a task management functionality to the one or more stakeholders.

In an exemplary embodiment, the enterprise IT system may be embedded within a Microsoft Office 365 environment. In an embodiment, the Microsoft Office 365 environment, utilizing native storage and connections to mitigate compatibility and security issues commonly associated with external systems. This offers a robust and scalable solution to the inefficiencies and delays inherent in conventional IT systems.

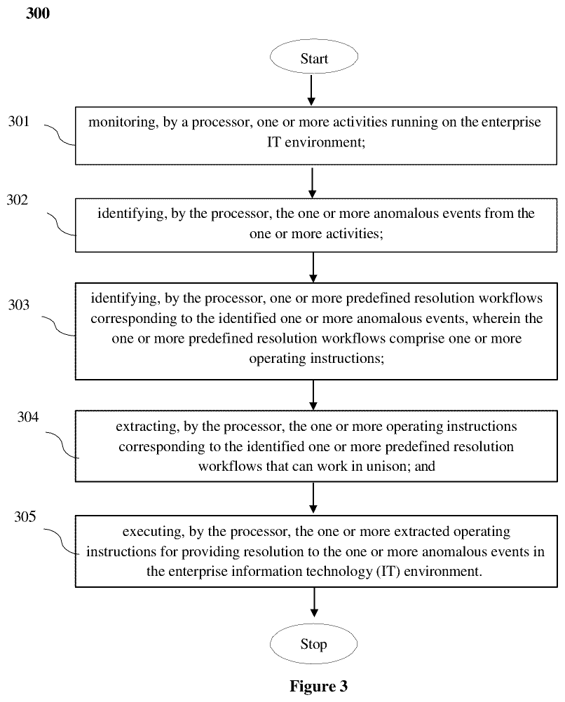

Now referring to FIG. 3, illustrates a flowchart describing a method (300) for providing automated resolution to the one or more anomalous events in the enterprise information technology (IT) environment, in accordance with at least one embodiment of the present subject matter. The flowchart is described in conjunction with FIG. 1 and FIG. 2. The method (300) starts at step (301) and proceeds to step (305).

In operation, the method (300) may involve a variety of steps, executed by the processor (201), for providing automated resolution to the one or more anomalous events in the enterprise IT environment.

At step (301), the method involves monitoring the one or more activities running on the enterprise IT environment.

At step (302), the method involves identifying the one or more anomalous events from the one or more activities.

At step (303), the method involves identifying the one or more predefined resolution workflows corresponding to the identified one or more anomalous events. In an embodiment, the one or more predefined resolution workflows may include the one or more operating instructions.

At step (304), the method involves extracting the one or more operating instructions corresponding to the identified one or more predefined resolution workflows that can work in unison.

At step (305), the method involves executing the one or more extracted operating instructions for providing resolution to the one or more anomalous events in the enterprise information technology (IT) environment.

Let us delve into a detailed example of the present disclosure.

Imagine a digital platform specifically designed to streamline IT support operations within a large enterprise. This platform integrates with existing IT infrastructure to offer automated resolutions for various anomalous events. For instance, consider a scenario where a user inadvertently interacts with a phishing email. The platform's processor monitors real-time activities across the enterprise IT environment using native tools like Microsoft Sentinel. Upon detecting the phishing attempt, the processor identifies the anomaly and retrieves a predefined resolution workflow from its centralized repository. The workflow includes steps to quarantine the affected user account and perform a security scan on the email. The system's bots, utilizing Microsoft Power Automate, execute these actions automatically, significantly reducing the mean time to resolution. The system also logs each step and generates a detailed report for IT security stakeholders, while employing predictive techniques to forecast and mitigate similar threats in the future.

### Working Example

Let's envision an enterprise IT support system called “Smart Support” designed to automatically resolve anomalous events specifically at Level 2 (L2) and Level 3 (L3) within an IT environment without the need for manual intervention by technicians.

Suppose a user reports a recurring performance issue with a critical application. Smart Support continuously monitors activities using its native monitoring platforms and identifies the issue as an L2 problem due to repeated application crashes. The system retrieves predefined resolution workflows for L2 issues from its centralized repository. Bots, configured for L2 and L3 tasks, automatically execute these workflows by analyzing logs, applying patches, and optimizing application configurations based on predefined Standard Operating Procedures (SOPs). If the issue persists and is identified as an L3 problem, the system's L3 bots further investigate the root cause, such as database inefficiencies or network bottlenecks, and apply advanced corrective measures. Throughout the process, Smart Support logs all actions, updates a real-time visualization dashboard with the current status, and sends automated alerts to relevant stakeholders, ensuring a swift and comprehensive resolution of the problem.

A person skilled in the art will understand that the scope of the disclosure is not limited to scenarios based on the aforementioned factors and using the aforementioned techniques and that the examples provided do not limit the scope of the disclosure.

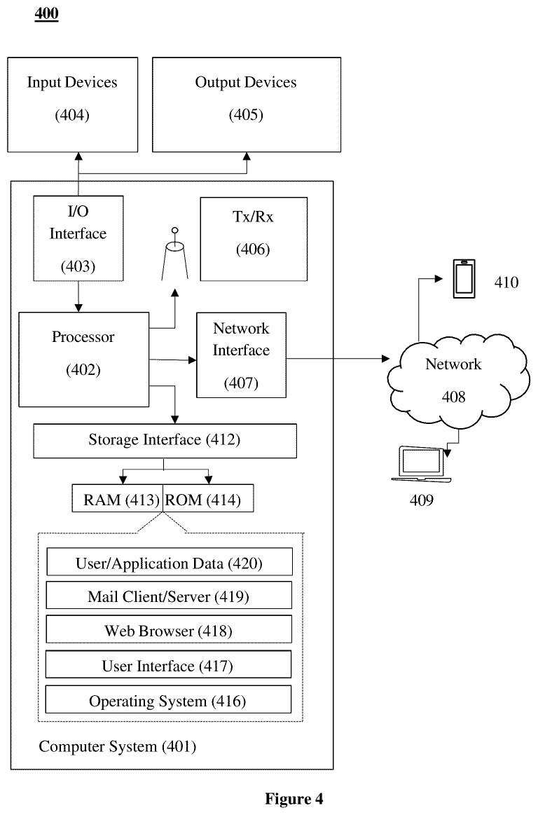

Now referring to FIG. 4, illustrates a block diagram (400) of an exemplary computer system (401) for implementing embodiments consistent with the present disclosure. Variations of computer system (401) may be used for providing automated resolution to the one or more anomalous events in the enterprise information technology (IT) environment. The computer system (401) may comprise a central processing unit (“CPU” or “processor”) (402). The processor (402) may comprise at least one data processor for executing program components for executing user-or system-generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface, coupled to the processor may be configured to facilitate communication between the system and one or more external devices or networks. The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C #, Microsoft. NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer for providing automated resolution to the one or more anomalous events in the enterprise IT environment. The at least one code section in the application server (101) causes the machine and/or computer including one or more processors to perform the steps, which includes monitoring the one or more activities running on the enterprise IT environment. Further, the processor may perform a step of identifying the one or more anomalous events from the one or more activities. Further, the processor may perform a step of identifying the one or more predefined resolution workflows corresponding to the identified one or more anomalous events. In an embodiment, the one or more predefined resolution workflows may include the one or more operating instructions. Furthermore, the processor may perform a step of extracting the one or more operating instructions corresponding to the identified one or more predefined resolution workflows. Moreover, the processor may perform a step of executing the one or more extracted operating instructions for providing resolution to the one or more anomalous events in the enterprise information technology (IT) environment.

Various embodiments of the disclosure encompass numerous advantages including a method for automated resolution to the one or more anomalous events in the enterprise information technology (IT) environment. The disclosed method and system have several technical advantages, but not limited to the following:
Efficient Automated Resolution: By automating the identification and resolution of anomalous events, the system reduces reliance on manual intervention, leading to comprehensive resolution, faster resolution times and decreased human error.
Efficient Handling of L2 and L3 Issues: The system's ability to handle Level 2 (L2) and Level 3 (L3) support issues through predefined workflows and operating instructions allows for complex problem resolution without requiring extensive human expertise.
Integration with Native Platforms: Utilization of native platforms, such as those within Microsoft Office 365, ensures seamless integration with existing enterprise systems, reducing compatibility and security issues associated with external tools.
Real-Time Monitoring and Reporting: Continuous monitoring of activities and real-time reporting to stakeholders ensure that issues are promptly identified and addressed, and that relevant parties are kept informed of the resolution progress.
Logging and Documentation: Detailed logging of actions taken during the resolution process provides valuable insights for future reference and helps in auditing and improving system performance.
Predictive Analysis: The system's use of predictive techniques to anticipate potential anomalies allows for proactive management, reducing the likelihood of incidents before they impact operations.
Accurate Resolution: Due to usage of predefined resolution workflow mapping for the anomalous events resulting in overcoming the challenges of no contextual understanding, incorrect diagnoses and issue misclassification.
Scalability: The system's design supports scalability, making it adaptable to growing and evolving enterprise environments, and capable of handling an increasing number of issues and users.
Compliance and Security: Integration with enterprise systems and adherence to predefined protocols ensure that the resolution process is secure and compliant with organizational standards.

In summary, these technical advantages solve the technical problem of delaying resolution, prolonged downtimes, inefficiencies, issue misclassification, failure to recognize the nuanced differences between similar problems, incorrect diagnoses, straining IT resources, potential for human error, and increased mean time to resolve (MTTR).

The claimed invention of a system and a method for automated resolution to the one or more anomalous events in the enterprise information technology (IT) environment involves tangible components, processes, and functionalities that interact to achieve specific technical outcomes. The system integrates various elements such as processors, memory, databases, encryption, authorization and authentication techniques to effectively perform one or more operations of the automated resolution platform.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for securely performing one or more operations in a user interface platform, brings about an improvement and technical advancement in the field of automated resolution to the one or more anomalous events in the enterprise information technology (IT) environment.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

We claim:

1. A method (300) for providing automated resolution to one or more anomalous events in an enterprise information technology (IT) environment, the method (300) comprising:
monitoring (301), by a processor, one or more activities running on the enterprise IT environment;
identifying (302), by the processor, the one or more anomalous events from the one or more activities;
identifying (303), by the processor, one or more predefined resolution workflows corresponding to the identified one or more anomalous events, wherein each predefined resolution workflow from the one or more predefined resolution workflows comprise one or more operating instructions;
extracting (304), by the processor, the one or more operating instructions corresponding to the identified one or more predefined resolution workflows; and
executing (305), by the processor, the one or more extracted operating instructions for providing resolution to the one or more anomalous events in the enterprise information technology (IT) environment.

2. The method (300) as claimed in claim 1, wherein monitoring the one or more activities, running on the enterprise IT environment, is performed in coordination with one or more native monitoring platforms hosted on the enterprise IT environment.

3. The method (300) as claimed in claim 1, wherein monitoring the one or more activities, running on the enterprise IT environment, corresponds to applying a set of predefined rules on the one or more activities.

4. The method (300) as claimed in claim 1, wherein identifying the one or more anomalous events from the one or more activities, is performed based on one or more tickets from one or more native ticketing platforms hosted on the enterprise IT environment, wherein the one or more anomalous events comprises scenarios from at least one of a non-complying user action on a regular task, clicking on link/URL on phishing email, downloading an attachment from an unknown source, entering credentials into a suspicious website, non-complying activity on the
enterprise IT environment, executable file as email attachment or a combination thereof.

5. The method (300) as claimed in claim 1, wherein the automated resolution is provided by one or more bots corresponding to the one or more anomalous events, wherein the one or more bots are communicatively coupled with the processor, wherein the one or more bots are configured for resolving the one or more anomalous events by mapping a specific bot from the one or more bots for a specific anomalous event from the one or more anomalous events.

6. The method (300) as claimed in claim 5, comprises storing the one or more predefined resolution workflows corresponding to the one or more anomalous events into a centralized repository, wherein the method comprises providing access of the one or more predefined resolution workflows, stored into the centralized repository, to the one or more bots corresponding to the one or more anomalous events.

7. The method (300) as claimed in claim 6, wherein identifying the one or more predefined resolution workflows corresponds to searching the one or more predefined resolution workflows corresponding to the identified one or more anomalous events, stored into the centralized repository.

8. The method (300) as claimed in claim 5, wherein the automated resolution provided by the one or more bots corresponds to one of Level 1 (L1) resolution, Level 2 (L2) resolution, Level 3 (L3) resolution, Level 4 (L4) resolution, or a combination thereof.

9. The method (300) as claimed in claim 1, wherein the one or more operating instructions comprises a sequence of operating instructions, to be executed by the one or more bots, in a predefined order for providing resolution to the one or more anomalous events.

10. The method (300) as claimed in claim 1, wherein the one or more operating instructions corresponds to one or more Standard Operating Procedures (SOPs) for providing resolution to the one or more anomalous events.

11. The method (300) as claimed in claim 1, comprises parsing the one or more operating instructions using one or more parsing tools.

12. The method (300) as claimed in claim 1, comprises reporting to one or more stakeholders on the one or more identified anomalous events and the one or more operating instructions executed for providing resolution to the one or more identified anomalous events, wherein reporting comprises sending alerts to the one or more stakeholders on one or more user devices associated with the one or more stakeholders.

13. The method (300) as claimed in claim 5, comprises logging each step of instruction from the one or more operating instructions, executed for providing resolution to the one or more anomalous events in the enterprise information technology (IT) environment, wherein logging corresponds to taking screenshot of action performed while executing the one or more operating instructions, wherein logging corresponds to maintaining history of actions performed by the one or more bots while executing the one or more operating instructions.

14. The method (300) as claimed in claim 1, comprises displaying a visualization dashboard to the one or more stakeholders, indicating one or more anomalous events, the one or more operating instructions executed for providing resolution to the one or more identified anomalous events, current status, and an impacting workflow, wherein displaying the visualization dashboard facilitates a task management functionality to the one or more stakeholders.

15. The method (300) as claimed in claim 1, comprises identifying the one or more bots corresponding to the one or more anomalous events based on one or more user profiles, wherein the one or more user profiles correspond to one or more access permissions provided to users for providing at least one of L1, L2, L3, L4, L5 resolutions and a combination thereof.

16. The method (300) as claimed in claim 1, comprising one or more predictive analysis techniques to predict risks of upcoming anomalous events based on monitoring the one or more activities.

17. The method (300) as claimed in claim 1, comprises allowing the one or more anomalous events to be validated by the one or more stakeholders, to confirm validity of the identified one or more anomalous events.

18. A system (100) to provide automated resolution to one or more anomalous events
in an enterprise information technology (IT) environment, the system (100) comprises:
a processor (201),
a memory (202) communicatively coupled with the processor (201), wherein the memory (202) is configured to store one or more executable instructions, which cause the processor (201) to:
monitor one or more activities running on the enterprise IT environment;
identify the one or more anomalous events from the one or more activities;
identify one or more predefined resolution workflows corresponding to the identified one or more anomalous events, wherein the one or more predefined resolution workflows comprise one or more operating instructions;
extract the one or more operating instructions corresponding to the identified one or more predefined resolution workflows; and
execute the one or more extracted operating instructions for providing resolution to the one or more anomalous events in the enterprise information technology (IT) environment.

19. A non-transitory computer-readable storage medium having stored thereon, a set of computer-executable instructions causing a computer comprising one or more processors to perform steps comprising:
monitoring one or more activities running on the enterprise IT environment;
identifying the one or more anomalous events from the one or more activities;
identifying one or more predefined resolution workflows corresponding to the identified one or more anomalous events, wherein the one or more predefined resolution workflows comprise one or more operating instructions;
extracting the one or more operating instructions corresponding to the identified one or more predefined resolution workflows; and
executing the one or more extracted operating instructions for providing resolution to the one or more anomalous events in the enterprise information technology (IT) environment.
